(19) United States
(12) Patent Application Publication
(10) Pub. No.: US 2012/0109544 A1
(43) Pub. Date: May 3, 2012

(54) DIGITAL COMPRESSION RECORDER WITH SPECIFICATION DATABASE SYSTEM AND METHOD

(75) Inventors: James FISH, Birmingham, MI (US); Jennifer Otto, Owatonna, MN (US); Dennis Hanson, Medford, MN (US)

(73) Assignee: SPX Corporation, Charlotte, NC (US)

(21) Appl. No.: 12/916,128

(22) Filed: Oct. 29, 2010

(51) Int. Cl. G01M 15/08

(52) U.S. Cl. 702/50; 73/114.16

(57) ABSTRACT

In accordance with one embodiment of the present invention, a system for measuring the cylinder compression of an engine is provided The system may include a microprocessor; a sensor operatively connected to the microprocessor, the sensor configured to measure a pressure; a memory operatively connected to the microprocessor, the memory configured to store a pressure detected by the sensor; and a database operatively connected to the microprocessor, the database configured to a store baseline pressure associated with an engine.

### FIELD OF THE INVENTION

The present invention relates generally to maintenance of internal combustion engines. More particularly, the present invention relates to a measurement and recording device for measuring and recording the cylinder compression in an internal combustion engine.

### BACKGROUND OF THE INVENTION

As part of routine maintenance for an internal combustion engine, such as an engine commonly found in automobiles and trucks, the cylinder compression is commonly measured. Multi-cylinder engines may have the cylinder compression for one or more of the cylinders measured. Different engines may have different specifications for an ideal range for cylinder compression. As a result, the measured compression must be compared against a specification for a particular engine type.

Currently, the nominal or specified compression range must be looked up by a mechanic, either in a paper manual, an electronic database that may be stored on a computer or accessed by the internet. Once the cylinder compression is measured, the mechanic often writes down the measured compression. Then the mechanic looks up the specified compression for the measured engine and compares the two values in order to make a determination about the status of the engine. Valuable time may be wasted as the mechanic leaves the engine measuring area to go find the standard specified compression for the engine. Human error may be introduced to the process either by a mechanic miswriting down the compression or the looked up standardized compression.

Further, it may be useful to compare the measured compression with a previously measured compression of the same engine in order for the performance of a specific engine may be tracked over time. Therefore, a tool that may assist a mechanic in the tasks of measuring an engine compression recording the measured compression and comparing the measured compression with a specified compression range may be desired.

### SUMMARY OF THE INVENTION

The foregoing needs are met, to a great extent, by the present invention, wherein in one aspect an apparatus is provided that in some embodiments

In accordance with one embodiment of the present invention, A system for measuring the cylinder compression of an engine is provided. The system may include a microprocessor; a sensor operatively connected to the microprocessor, the sensor configured to measure a pressure; a memory operatively connected to the microprocessor, the memory configured to store a pressure detected by the sensor; and a database operatively connected to the microprocessor, the database configured to a store baseline pressure associated with an engine.

In accordance with another embodiment of the present invention, a method for measuring a compression pressure of an engine is provided. The method may include: attaching a measuring device to the engine; starting the engine; measuring the compression pressure; saving the compression pressure on a memory associated with the measuring device; and displaying a baseline pressure for the tested engine on the measuring device.

In accordance with yet another embodiment of the present invention, a system for measuring the cylinder compression of an engine is provided. The system may include: means for processing data; means for sensing pressure operatively connected to the processing means, means for storing data operatively connected to the processing means, the means for storing data configured to store a pressure detected by the sensing means; and a second means for storing data operatively connected to the processing means, the second means for storing data configured to a store baseline pressure associated with an engine.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a digital compression recorder in accordance with an embodiment of the invention.

FIG. 2 is a perspective view of a kit that includes a digital compression recorder along with related tools that may be useful in using digital compression recorder as well as a carrying case for the kit.

FIG. 3 is a schematic diagram of a digital compression recorder in accordance with an embodiment of the invention.

FIG. 4 is a flowchart illustrating steps that may be used when using the digital compression recorder.

### DETAILED DESCRIPTION

The invention will now be described with reference to the drawing figures, in which like reference numerals refer to like parts throughout. An embodiment in accordance with the present invention provides a digital compression recorder. In some embodiments the digital compression recorder may record a compression associated with a particular cylinder in an internal combustion engine. The compression recorder may associated with a particular engine, and also a particular cylinder within the engine.

Some embodiments the compression recorder may be used to measure and record compression of various cylinders within the engine. The compression recorder may record the compression which may be recalled and reviewed for future reference. In addition, some embodiments of the compression recorder may also contain a reference compression range that may be used to compare the measured compression verses a baseline compression range provided by the original manufacturer or another organization.

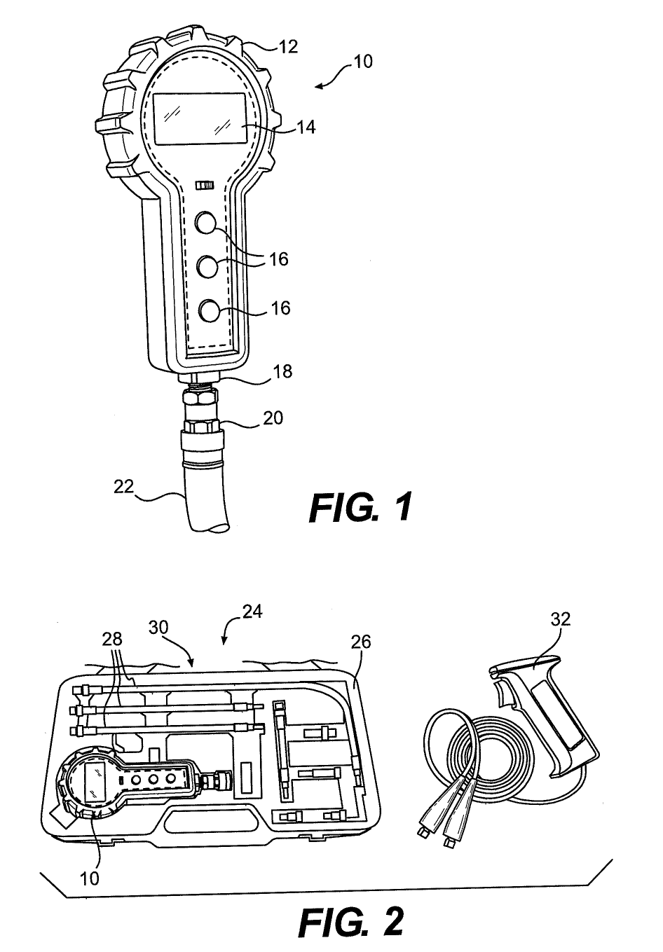

FIG. 1 illustrates a digital compression recorder 10 in accordance with an embodiment of the invention. The compression recorder 10 includes a housing 12. The housing 12 may be made of a impact resistant plastic, polycarbonate, medal, or any other suitable material. Preferably, the housing 12 will sized so that the compression recorder 10 can be a portable handheld tool.

The compression recorder 10 includes a display screen 14. The display screen 14 maybe configured to display not only a measured compression but also a baseline compression of the compression range for a particular engine. The compression recorder 10 may include an input device 16. An input device 16 may be input buttons or keys as shown in FIG. 1. In other embodiments of the invention, the input device 16 maybe incorporated with the display screen 14 so that the display screen 14 is a touch screen that may be able to receive inputs of a user.

In some embodiments of the invention, the compression recorder 10 may include an input device 16 and can assist the user in associating a measured pressure with a particular engine type and/or cylinder within the engine type. Further, the input device 16 may have sufficient input keys or functions to allow a user to select and view past measurements for a selected engine and/or cylinder as well as baseline pressure ranges for a particular engine type.

A compression recorder 10 may also include an interface 18. An interface 18 may allow a hose adapter 20 to connect a hose 22 to a compression recorder 10. The hose 22 is attached to an engine in accordance with techniques already well known and will not be discussed further. However, one of the ordinary skilled in art will appreciate that the hose 22 will provide a fluid connection between the cylinder that is being measured for its compression with the compression recorder 10 through the hose adapter 20 and the interface 18. A sensor 35 (which will be discussed in detail further below) is exposed to the pressure from the cylinder fluidly transferred via the hose 22, the house adapter 20, and the interface 18.

FIG. 2 illustrates a kit 24 that may be packaged and included with the compression recorder 10 when a compression recorder 10 is purchased. In other embodiments of the invention there may be no kit accompanying the compression recorder 10. In other embodiments of the invention a kit 24 having different tools and accessories than that shown in FIG. 2 may also be packaged and included with the compression recorder 10.

As shown in FIG. 2, the kit 24 includes a carrying case 26. The carrying case 26 maybe blow molded and include slots 28 for various parts 30 to be securely held within the case 26. Case 26 may also include a lid (removed in FIG. 2 to better show the contents of the case 26) the lid (not shown in FIG. 2) may enclose the contents of the kit 24 to protect the contents of the kit. The kit 24 may include various parts 30 such as, but not limited to, nor requiring, the digital compression recorder 10, a 14 millimeter hose assembly of standard length, a 14 millimeter hose assembly of a longer length, a 14 millimeter hose assembly of a 6 inch length for small engine testing and measuring, an 18 millimeter hose assembly of standard length, an air hold quick connect valve, an 18 millimeter adapter having a long reach, a 12 millimeter adapter, a 10 millimeter adapter of repair kit.

In some embodiments the kit 24 may also include a remote starter 32. A remote starter 32 maybe connected to the engine to allow the user to remotely start the engine without needing to be inside the car. Rather, the mechanic or user may be located near the engine and viewing the compression recorder 10 can be physically located near the engine and may start the engine with the remote starter 32.

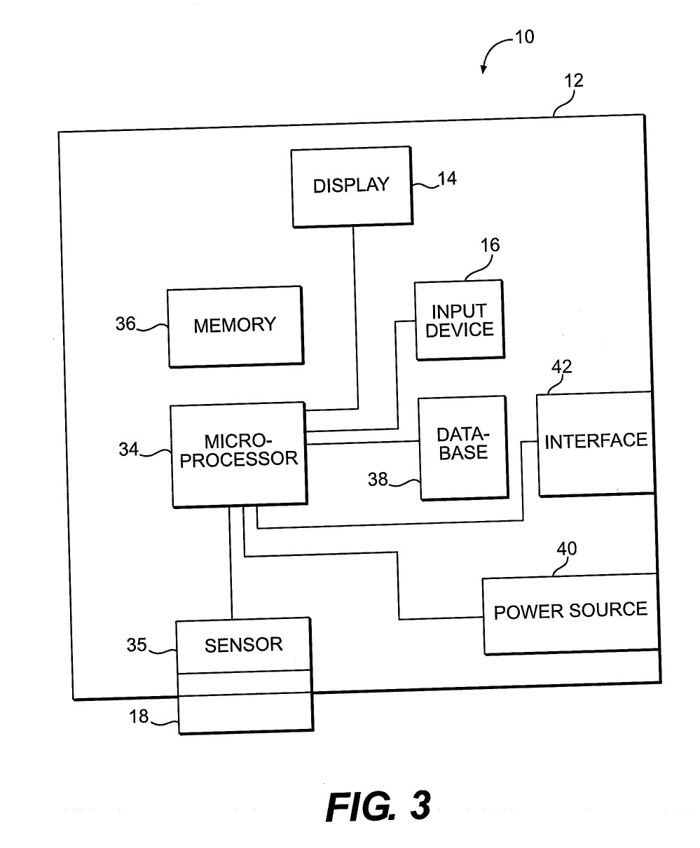

FIG. 3 is a schematic diagram of a compression recorder 10 in accordance with the embodiment of the invention. The compression recorder 10 includes a housing 12. The compression recorder 10 may include a microprocessor 34. The microprocessor 34 may be configured to connect various parts of the compression recorder 10 and conduct processing of information and communication between the various parts.

The compression recorder 10 may include a sensor 35. The sensor 35 is configured to be able to detect a pressure or compression of the cylinder of the engine to be tested. The sensor 35 is exposed to the pressure generated in the cylinder via the interface 18, the hose adapter 20 and hose 22 (hose adapter 20 and hose 22 are shown in FIG. 1). The sensor 35 is configured to turn the pressure into an electronic signal and send that electronic signal to the microprocessor 34.

The compression recorder 10 may also include a memory 36. The memory 36 is connected to the microprocessor 34 and may be configured to store a pressure sensed by the sensor 35. The memory of 36 may also store a cylinder number, engine type, and/or specific engine identification information associated with a measured pressure. The memory 36 may be accessed, in some instances months or years later, to detect a previously measured pressure that is associated with a particular cylinder within a particular engine.

A display 14 is included and connected to the microprocessor 34. The display 34 may be configured to display a pressure sensed by the sensor 35. The display 14 may also be able to display information contained within the memory 36 such as a previously sensed pressure and identifying information showing the displayed pressure is associated with a particular cylinder within a particular engine, measured on a particular date.

An input device 16 is also operatively connected to the microprocessor 34. The input device 16 may be configured to allow a user to associate a particular engine and/or cylinder with a measured pressure. Optionally, the input device may be configured to allow a user to associate a date with the measured pressure. The input device 16 may also be configured to allow a user to access data stored in the memory 16 and allow that start data to be displayed on the display 14.

In some embodiments of the invention the compression recorder 10 may also include a database 38. The database 38 can store baseline data such as a baseline pressure range for a particular engine type. Often manufactures or other organizations may set standard baseline compression data for a particular type of engine. This baseline data may be stored in the database 38 for future retrieval. Input device 16 may be configured to allow the user to access the list stored in the database 38 and allow the data to be displayed on the display 14. The display 14 may be configured to show not only a baseline pressure range for a particular engine storing the database but also a measured or actually pressure sense by the sensor 35. With the measured and baseline pressures both displayed the user may easily compare the pressures. In some embodiments of the invention, the tolerances of the baseline data may also be saved so that the display 14 may be able to indicate whether the measured pressure is within and acceptable tolerance from the baseline data.

From time to time the baseline data may need to be updated. For example, new engines may come available on the market for which baseline data needs to be provided. Some compression recorders 10 maybe able to have its database 38 updated so that new updated data can be stored on the database 38. In order to update the database 38, some embodiments of compression recorder 10 may include an interface 42 which maybe configured to interface with a computer, a database or internet in order to download additional or updated baseline information for saving in the database 38. The interface 42 may be a USB port or any other suitable port for downloading data.

In some embodiments of the invention, the interface 42 may also be a wireless interface and may be able to download data via any wireless technology suitable for downloading data.

In order to power the compression recorder 10, a power source 40 will also be provided. Some embodiments in the invention, the power source 40 may be a battery and other embodiments in the invention, the power source 40 may be power obtained via cord to a wall socket allowing the compression recorder 10 to be powered from standard line voltage. Whether the power source 40 is a DC power source such as a battery or AC line voltage one, of ordinary skill the art can appreciate the compression recorder 10 may be modified to run from either or both power sources. In some embodiments where the power source 40 is a battery, the battery may be configured to be rechargeable when connected to AC line voltage. The power source 40 may also be configured to operate either standard line voltage or a battery.

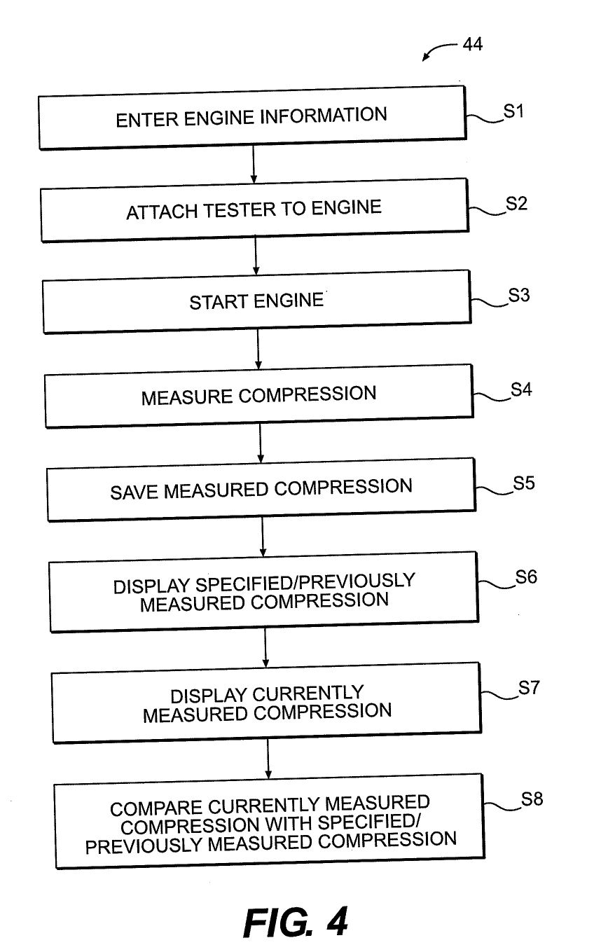

FIG. 4 is a flow chart illustrating steps that may be accomplished by a user and detecting and saving a compression associated with a cylinder and a engine. As shown in FIG. 4, the method includes entering engine information into the compression recorder 10 in step S1. The engine information may include an engine type unique identifier for a specific engine and a particular cylinder within that engine for which the compression measurement will be taken. In step S2, the compression recorder 10 is attached to the engine via the interface 18 hose adapter 20 and hose 22.

In step S3, the engine is started. Optionally, the engine may be started via the remote starter 32. In other embodiments of the invention, the engine may be started using the standard engine power starting procedure.

In step S4, the user may actuate the input device 16 in order to cause the compression recorder 10 to measure the compression. Step S5, the measured compression may be saved in the memory 36, the measured compression may also be displayed on the display screen 14.

In step S6, a previously measured compression and/or a baseline or specified compression may be displayed on the display screen 14 the display of the baseline compression data and/or previous compression data may occur automatically or it may be done by a user inputting via the input device 16 and request for the display screen 14 to display the previously measured and/or the baseline compression information. In step S7, the display 14 may display the currently measured compression. This may be done automatically or in some embodiments of invention may be done when a user request that the currently measured compression be displayed via the input device 16.

In step S8, the currently measured compression is compared with either the specified/baseline data and/or previously measured compression for the same cylinder and engine. By comparing the currently measured compression with the baseline compression a user can determined if any further maintenance is required. Further, by comparing the currently measured compression with the previously measured compression a user can also determine whether further maintenance is required and also determine a deterioration rate of performance since the last time the cylinder compression was taken.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for measuring the cylinder compression of an engine comprising:
a microprocessor;
a sensor operatively connected to the microprocessor, the sensor configured to measure a pressure;
a memory operatively connected to the microprocessor, the memory configured to store a pressure detected by the sensor; and
a database operatively connected to the microprocessor, the database configured to a store baseline pressure associated with an engine.

2. The system of claim 1, further comprising a display operatively connected to the microprocessor, the display configured to display at least one of a measured pressure and a baseline pressure.

3. The system of claim 1, further comprising an input device operatively connected to the microprocessor, the input device configured to allow a user to input a type of engine associated with a pressure measured by the system.

4. The system of claim 3, wherein the system, is configured to allow a user to select a baseline pressure stored in the database to be displayed on the display by operating the input device.

5. The system of claim 3, wherein the system is configured to allow a user to associate a particular cylinder of an engine with a measured pressure and store the measured pressure with the associated cylinder number.

6. The system of claim 1, further comprising a mechanical interface configured to attach to a hose configured to provide a fluid connection between the interface and a cylinder to have an associated pressure measured, the interface configured to expose the sensor to the pressure associated with the cylinder.

7. The system of claim 1, further comprising an electronic interface operatively connected to the microprocessor and the database, the electronic interface configured to interface with a data source to download baseline pressures from the data source to the database.

8. The system of claim 7, wherein the data source is one of the following sources, a website, a second computer database, an optical disk or a flash memory device.

9. The system of claim 7, wherein the electronic interface is configured to receive data via a wireless network.

10. The system of claim 1, wherein the microcontroller is configured to save measured pressures in the database as base line pressures.

11. The system of claim 1, wherein the microprocessor, the sensor, the memory, and the database are contained in a portable hand held unit.

12. The system of claim 11, further comprising a kit including hose connectors for connecting the sensor to an engine.

13. The system of claim 12, wherein the kit comprises a standard 14 mm hose assembly, a long 14 mm hose assembly, and 14 mm hose assembly for a small engine, a standard 18 mm hose assembly, an air hold quick connect valve, a long reach 18 mm adapter, a 12 mm adapter, and a 10 mm adapter.

14. The system of claim 11, further comprising a carrying case for components associated with the system.

15. The system of claim 11, further including a remote starter for allowing a user of the system to remotely start an engine to have a pressure measured.

16. A method for measuring a compression pressure of an engine comprising:
attaching a measuring device to the engine;
starting the engine;
measuring the compression pressure;
saving the compression pressure on a memory associated with the measuring device; and
displaying a baseline pressure for the tested engine on the measuring device.

17. The method of claim 16, further comprising: downloading baseline pressures onto a database associated with the measuring device.

18. The method of claim 17, wherein the baseline pressures are pressures measured by the measuring device.

19. The method of claim 17, further comprising associating a measured pressure with an engine type and associating the baseline pressures with engine types.

20. A system for measuring the cylinder compression of an engine comprising:
means for processing data;
means for sensing pressure operatively connected to the processing means,
means for storing data operatively connected to the processing means, the means for storing data configured to store a pressure detected by the sensing means; and
a second means for storing data operatively connected to the processing means, the second means for storing data configured to a store baseline pressure associated with an engine.
